(19) United States
(12) Patent Application Publication
(10) Pub. No.: US 2008/0248835 A1
(43) Pub. Date: Oct. 9, 2008

(54) ACCESSORY COMMUNICATION METHOD AND SYSTEM FOR MOBILE SERVICES

(75) Inventors: Anders Hansson, Klagerup (SE); Michal Stala, Lund (SE); Andreas Munchmeyer, Rydeback (SE); Johan Stenfors, Bara (SE); Magnus Rosell, Lund (SE); Pablo Cases, Helsingborg (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/742,141

(22) Filed: Apr. 30, 2007

Related U.S. Application Data
(60) Provisional application No. 60/910,135, filed on Apr. 4, 2007.

(51) Int. Cl. H04M 1/00

(52) U.S. Cl. 455/559

(57) ABSTRACT

A mobile device includes a communications interface and a processor configured to determine whether an accessory device has been attached via the communications interface. The processor is further configured to configure a high bandwidth link to the accessory device via an initial low power link to the accessory device. The processor is further configured to connect to the accessory device via the high bandwidth link when necessary to perform an operation.

### BACKGROUND

1. Technical Field of the Invention

Implementations described herein relate generally to mobile devices and, more particularly, to establishing connections between accessories and mobile devices.

2. Description of Related Art

Accessory or peripheral devices are known for use in conjunction with various electronic devices. For example, peripherals such as keyboards, pointing devices, speakers, monitors, network adapters and the like may be configured to extend the core functionality of the electronic devices to which they are attached.

Although various attachment standards and protocols have been used over the years, many accessory devices are developed to communicate with other devices via common interfaces and protocols, such as parallel interfaces, serial interfaces, universal serial bus (USB) interfaces, and IEEE 1394 (“Firewire”) interfaces. More recently, wireless interfaces have been developed for exchanging information.

### SUMMARY

According to one aspect a method may include receiving a request to configure a high speed link between a first device and a second device via a low speed link between the first device and the second device; assigning a high bandwidth channel to the high speed link; transmitting a channel identifier corresponding to the assigned high bandwidth channel to the second device via the low speed link; determining whether the high speed link is necessary to perform an operation on the first device; enabling the high speed link via the identified channel when it is determined that high speed link is necessary to perform and operation on the first device; and exchanging data between the first device and the second device via the high speed link.

Additionally, the method may include authenticating the second device via the low speed link.

Additionally, the authenticating may be performed prior to assigning the high bandwidth channel to the high speed link.

Additionally, the authenticating may include receiving an encrypted authentication request via the low speed link; determining whether the encrypted authentication request was encrypted using an authorized encryption key; and authenticating the second device when it is determined that the encrypted authentication request was encrypted using an authorized encryption key.

Additionally, the encryption key may be a private key associated with an authorized manufacturer of the second device.

Additionally, the method may include receiving a request to disable power charging from the second device.

Additionally, the request to disable power charging may be received via the low speed link.

Additionally, the high speed link may include a universal serial bus (USB) interface.

Additionally, the identified high speed channel may include a USB channel, where enabling the high speed link may include setting a vbus associated with the identified USB channel to high.

Additionally, the high speed link may include an IEEE 1394 interface.

Additionally, the first device may include a mobile communication device and the second device may include a high bandwidth accessory device.

Additionally, the high bandwidth accessory device may include one of a mobile television receiver or a wireless networking adapter.

Additionally, the method may include determining whether a disconnect request has been received and disabling the high speed link when it is determined that the disconnect request has been received.

Additionally, the disconnect request may indicate that a sleep command has been received from an application executing on the first device.

In a second aspect, a mobile device may include a communications interface and a processor configured to: determine whether an accessory device has been attached via the communications interface, configure a high bandwidth link to the accessory device via an initial low power link to the accessory device, and connect to the accessory device via the high bandwidth link when necessary to perform an\operation.

Additionally, the communications interface may include a universal serial bus (USB) interface.

Additionally, the processor may be further configured to authenticate the accessory device prior to configuring the high bandwidth link.

Additionally, the authentication may include a public-key cryptographic authentication.

Additionally, the low power link may require less power than the high bandwidth link.

In a third aspect, a device may include means for authenticating a second device to a first device via a low power link; means for configuring a high bandwidth link between the first device and the second device via the low power link upon authentication of the second device to the first device; and means for connecting the first device to the second device via the high bandwidth link.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary system in which systems and methods described below may be implemented;

FIG. 2 is a diagram of an exemplary mobile device of FIG. 1;

FIG. 3 is a diagram of an exemplary accessory device of FIG. 1; and

FIGS. 4A-4B are flowcharts of an exemplary process for configuring communication between the mobile device and the accessory device of FIG. 1.

### DETAILED DESCRIPTION OF EMBODIMENTS

The following detailed description of the invention refers to the accompanying drawings. The same reference numbers in different drawings may identify the same or similar elements. Also, the following detailed description does not limit the invention.

A system and a method are described for configuring a high bandwidth channel between a mobile device and an accessory device. A first device (e.g., a mobile telephone) be connected to a second device (e.g., a mobile television receiver). The first device may authenticate the second device and may receive configuration requests from the second device via a low power link. A high bandwidth channel may be configured via the low power link and enabled when necessary to facilitate the exchange of data between the first device and the second device.

### Exemplary System

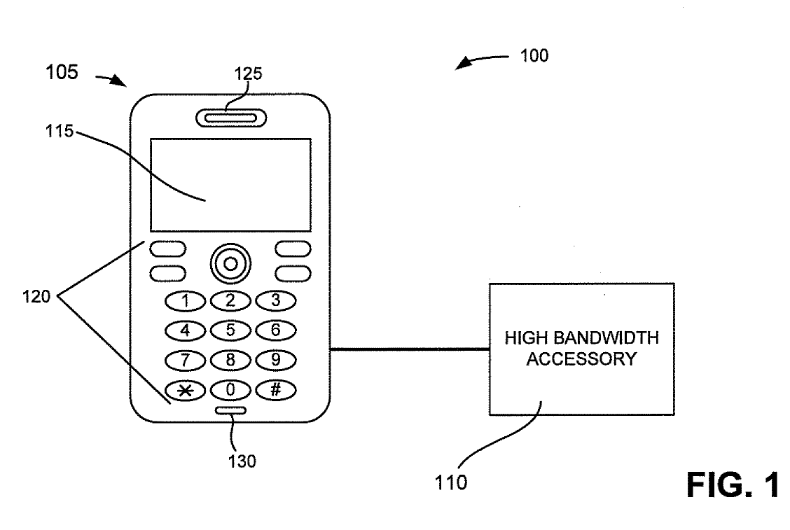

FIG. 1 is a diagram of an exemplary system 100 in which systems and methods described herein may be implemented. As illustrated in FIG. 1, system 100 may include mobile device 105 and high bandwidth accessory device 110. Mobile device 105 may include a display 115, a keypad 120, a speaker 125, and a microphone 130. Mobile device 105 and accessory device 110 may include additional components and features commensurate with their respective functions.

Mobile device 105 may include any of a variety of electronic devices such as cellular radiotelephones; Personal Communications System (PCS) devices that may combine a cellular radiotelephone with data processing, facsimile and data communications capabilities; Personal Digital Assistants (PDAs); laptop and/or palmtop computers; personal or portable media players, such as digital music and/or video players; and/or other similar types of devices.

High bandwidth accessory device 110 may include a device configured to operate in conjunction with mobile device 105, so as to increase the functionality of mobile device 105. Examples of suitable high bandwidth accessory devices 110 may include network adapter devices, television and/or radio receivers, external storage devices, etc.

In one implementation described below, mobile device 105 may communicate with high bandwidth accessory device 110 using a number of communication protocols or “bearers”, such as the universal serial bus (USB) protocol or the IEEE 1394 (“Firewire”) protocol.

### Exemplary Mobile Device Configuration

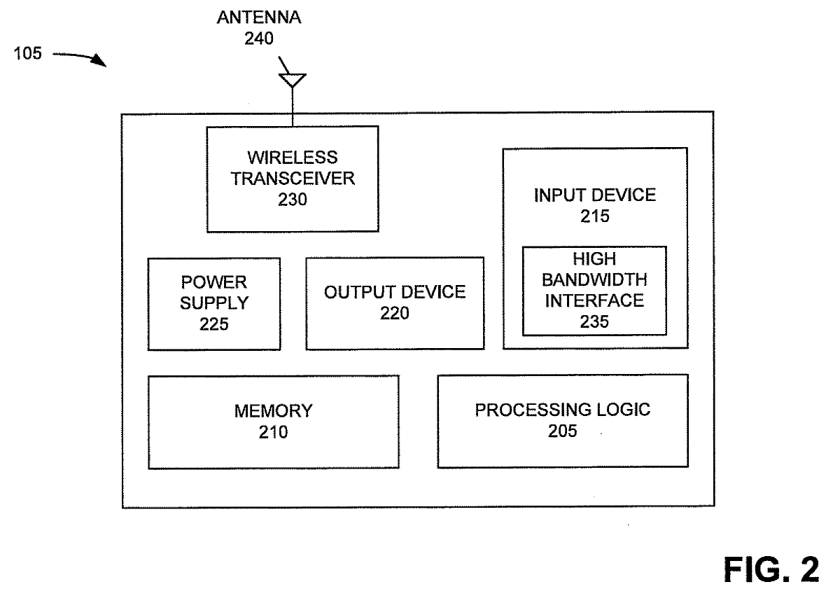

FIG. 2 is a diagram illustrating exemplary components of mobile device 105. As illustrated in FIG. 2, mobile device 105 may include processing logic 205, a memory 210, input device 215, output device 220, power supply 225, wireless transceiver 230, high bandwidth interface 235, and antenna 240. It will be appreciated that mobile device 105 may include other components (not shown) that aid in receiving, transmitting, and/or processing data. Moreover, it will be appreciated that other configurations are possible.

Processing logic 205 may include any type of processor, microprocessor, or combinations of processors that may interpret and execute instructions. In other implementations, processing logic 205 may be implemented as or include an application specific integrated circuit (ASIC), a field programmable gate array (FPGA), or the like. Memory 210 may include a random access memory (RAM) or another type of dynamic storage device that may store information and instructions for execution by processing logic 205, a read only memory (ROM) or another type of static storage device that may store static information and instructions for the processing logic 205, and/or some other type of magnetic or optical recording medium and its corresponding drive for storing information and/or instructions.

Consistent with aspects described herein, memory 210 may include applications and drivers suitable for enabling the configuration and operation of high bandwidth accessory device 110 via high bandwidth interface 235. Exemplary applications may include mobile television reception and wireless networking applications. Suitable drivers for implementing these applications via high bandwidth interface 235 may be provided. These drivers may be generic drivers with respect to hardware implemented within high bandwidth accessory device 110, provided that they support the applications in conjunction with data received via interface 235.

Input device 215 may include a device that permits a user to input information to mobile device 105, such as an interface port, a keypad, a keyboard, a mouse, a pen, a microphone, one or more biometric mechanisms, and the like. In one exemplary implementation, input device 215 may include a high speed interface 235, such as a USB or IEEE 1394 interface. Output device 220 may include a device that outputs information to the user, such as a display, a printer, a speaker, etc. Power supply 225 may include a battery, or the like, for providing power to the components of mobile device 105.

Wireless transceiver 230 may include a transceiver device capable of transmitting and receiving data and control signals using a wireless communications protocol such as a cellular radiotelephone protocol (e.g., GSM (global system for mobile communications), PCS (personal communication services), FDMA (frequency division multiple access), CDMA (code division multiple access), TDMA (time division multiple access), etc.). In additional implementations, wireless logic 230 may use short distance wireless communication protocols such as the Bluetooth protocol, one or more of the IEEE 802.11 protocols, the WiMax protocol, the Ultra Wideband protocol, or any other suitable wireless communication protocol, such as the protocol for use with high bandwidth interface 235. Antenna 240 may include, for example, one or more directional antennas and/or omni directional antennas.

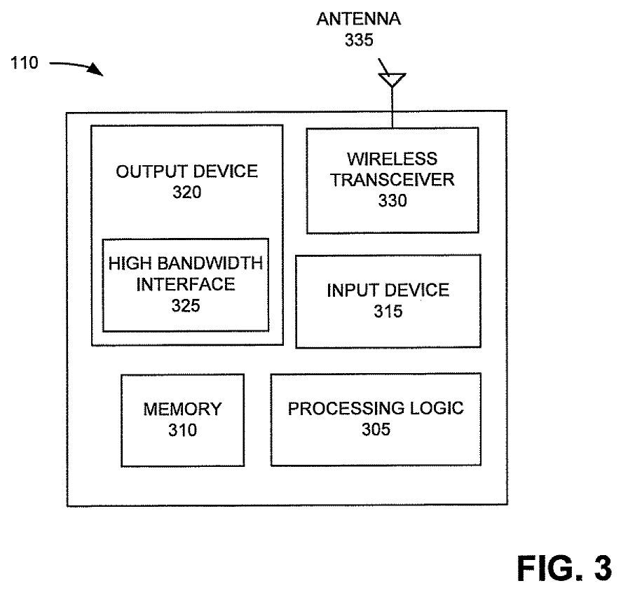

FIG. 3 is an exemplary diagram of high bandwidth accessory device 110. As illustrated, high bandwidth accessory device 110 may include processing logic 305, memory 310, input device 315, output device 320, high bandwidth interface 325, wireless transceiver 330, and an antenna 335. It will be appreciated that high bandwidth accessory device 110 may include other components (not shown) that aid in receiving, transmitting, and/or processing data. Moreover, it will be appreciated that other configurations are possible.

As with processing logic 205 described above, processing logic 305 may also include any type of processor, microprocessor, or combinations of processors that may interpret and execute instructions. As will be described in additional detail below, processing logic 305 may be configured to receive data via wireless transceiver 330, and format the data for delivery to mobile device 105 via high bandwidth interface 325. Moreover, processing logic 305 may be configured to establish one or more communication links with mobile device 105 via interface 325.

Memory 310 may include a random access memory (RAM) or another type of dynamic storage device that may store information and instructions for execution by processing logic 305, a read only memory (ROM) or another type of static storage device that may store static information and instructions for the processing logic 305, and/or some other type of magnetic or optical recording medium and its corresponding drive for storing information and/or instructions.

Input device 315 may include a device that permits a user to input information or commands to high bandwidth accessory device 110, such as a keypad having one or more buttons, a keyboard, a mouse, a pen, a microphone, one or more biometric mechanisms, and the like. Output device 320 may include a device that outputs data to mobile device 205 via high bandwidth interface 325.

Wireless transceiver 330 may include a transmitter and receiver device capable of enabling exchange of data and control signals between high bandwidth accessory device 110 and other device, such as RF transmitters, personal computers, PDA's, etc. using suitable communications protocols. Exemplary communications protocols may include a digital television transmission protocol (e.g., DVB-H) and or wireless communications protocols, such as the 802.x family of wireless networking protocols (e.g., WiFi, UltraWideband, WiMax, Bluetooth, Zigbee, etc.). Antenna 335 may include, for example, one or more directional antennas and/or omni directional antennas.

As will be described in detail below, mobile device 105 may enhance its functionality by communicating with high bandwidth accessory device 110 via interfaces 235 and 325, respectively. As will be described in additional detail below, processing logic 205 in mobile device 205 and processing logic 305 in high bandwidth accessory device 110 may establish an initial low bandwidth link via interfaces 235 and 325, respectively. Such a low bandwidth link may be a low power link configured to require less power from power supply 225 to configure and maintain. Subsequent to creation of the low bandwidth link, a high bandwidth link may be configured and enabled when necessary to enable efficient delivery of high bandwidth data from high bandwidth accessory device 110 to mobile device 105.

In one exemplary implementation, high bandwidth accessory device 110 may include a wireless networking adapter configured to provide wireless networking capabilities (e.g., WiFi capabilities) to mobile device 105. Upon setup of a high bandwidth link via a low bandwidth link, the high bandwidth link may be disabled prior to additional mobile or networking devices connecting to high bandwidth accessory device 110.

In an additional implementation, high bandwidth accessory device 110 may include a television receiver configured to provide real-time video broadcast data to mobile device 105 for viewing/recording on mobile device 105.

Mobile device 105 and high bandwidth accessory device 110 may perform these operations and other operations in response to processing logic 205 and 305, respectively, executing software instructions contained in a computer-readable medium, such as memory 210 or 310, respectively. A computer-readable medium may be defined as a physical or logical memory device and/or carrier wave.

The software instructions may be read into memory 210 from another computer-readable medium or from another device via, for example, wireless transceiver 230 or input device 215. The software instructions contained in memory 210 may cause processing logic 205 and processing logic 305 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

### Exemplary Processing

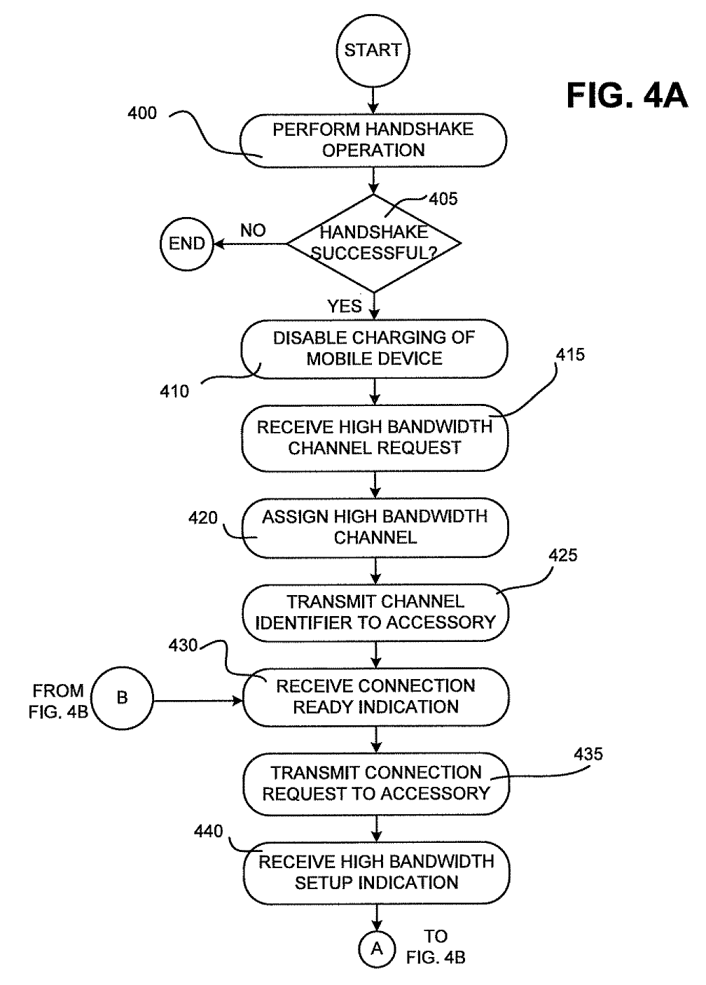

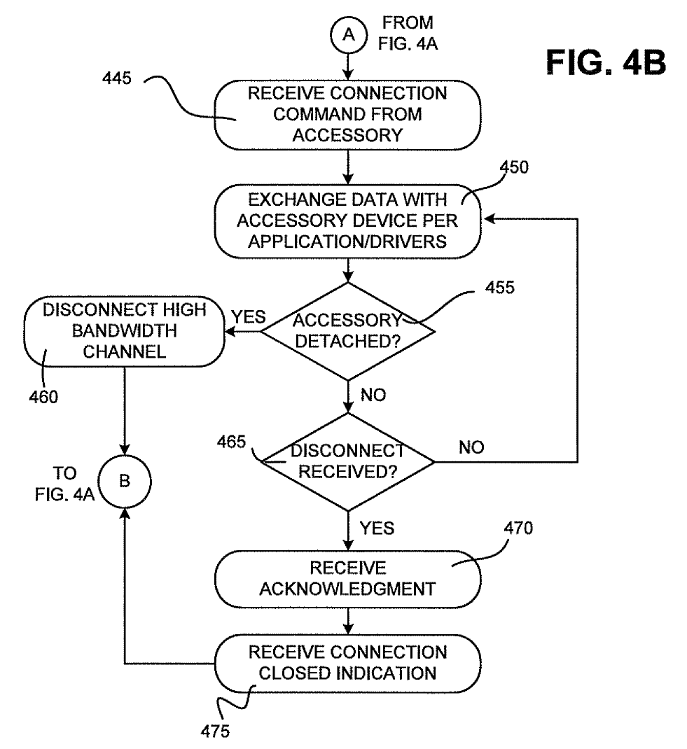

FIGS. 4A-4B are flowcharts of an exemplary process for facilitating communication between mobile device 105 and accessory device 110. Processing may begin upon establishing a physical connection between mobile device 105 and accessory device 110, via, e.g., interfaces 235 and 340. For example, a suitable cable, such as a USB or IEEE 1394 cable, may be connected between interface 235 on mobile device 105 and interface 340 on accessory device 110.

Once physically connected, a handshake operation may be performed between accessory device 110 and mobile device 150 via a low bandwidth link on interfaces 235 and 340 (block 400). In various implementations, the handshake operation may be initiated by accessory device 110, while in other implementations, the handshake operation may be initiated by mobile device 105. In one exemplary implementation, handshake operation may authenticate accessory device 110 to mobile device 105 prior to communication of additionally accessory-specific messages or signals. For example, accessory device 110 may encrypt a handshake message using a private encryption key known only to authorized accessory manufacturers. Upon receipt of the encrypted handshake message, mobile device 105 may decrypt the handshake message using a corresponding encryption key, such as a public key or shared private key. Upon successful decryption of the handshake message, mobile device 105 may be confident that accessory device 110 is an authorized device. Any suitable encryption/decryption methodology may be used, such as the RSA public-key cryptographic algorithm or the Diffie-Hellman key exchange protocol.

In one implementation, the handshake operation may be initiated via one or more suitable AT or “attention” commands transmitted by accessory device 110 to mobile device 105 via high bandwidth interface 235. As is known, various AT commands may be recognized by mobile device 105 for initiating certain functions or providing information to mobile device 105. Instances of AT commands may include parameter values that further define variables associated with respective commands.

It may be determined whether the handshake operation was successful (block 405). If the handshake operation was not successful (block 405-NO), the process may end and additional accessory setup and control messages and data may not be exchanged between accessory device 110 and mobile device 105.

However, if the handshake operation was successful (block 405-YES), charging of mobile device 105 via interface 235 may be disabled (block 410). Many mobile devices 105 utilize a common interface port for both charging a battery on the mobile device and exchanging data and/or information between multiple devices. In this implementation, mobile device 105 may operate as a slave device configured to typically draw power from a host device connected via interface 235. Because accessory device 110 does not perform battery charging functions, this feature may be disabled.

Mobile device 105 may receive a high bandwidth channel request from accessory device 110 (block 415). In one implementation, this request may designate the application (or a protocol supporting the application) whose data will be transmitted via the channel (e.g., wireless LAN data, media, etc.) and an underlying bearer that will support the channel (e.g., USB, IEEE 1394, etc.). In response, mobile device 105 may assign a high bandwidth channel (e.g., a port) (block 420) and transmit a response identifying the assigned channel back to accessory device 110 (block 425). At this point, although a high bandwidth channel has been assigned, the channel is not yet actively connected. This results in significant battery or power savings, due to the higher power requirements for operating the high bandwidth channel versus the low bandwidth link.

Upon receipt of the channel details, mobile device 105 may receive an indication from accessory device 110 that it is ready to receive a connection request from mobile device 105 to communicate via the high bandwidth channel (block 430). In one implementation, this request may be initiated by an application executed by processor 205, such as a television application or networking application. For example, following physical connection of a mobile television accessory device 110, a user of mobile device 105 may launch a mobile television application. The mobile television application may initiate the transmission of a connection request to mobile television accessory device 110 (block 435).

In response, mobile device 105 may receive an indication that the high bandwidth interface has been setup (block 440). In one implementation, this indication may indicate that a vbus or other power source associated with interface 235 has been set to high. Depending on the underlying bearer supporting the high bandwidth channel (e.g., USB, IEEE 1394, etc.), additional handshaking and setup messaging may be performed. Mobile device 105 may receive a command from accessory device 110 indicating that the high bandwidth channel has been connected (block 445—FIG. 4B). At this point, the high bandwidth channel is active and the executing application and its underlying protocol operate to exchange information between accessory device 110 and mobile device 105 via interfaces 340 and 235, respectively (block 450).

In one implementation, the underlying application may interact with one or more drivers maintained on memory 210. These drivers are configured to generically interact with accessory device 110 via the high bandwidth interface. In conjunction with the drivers residing on mobile device 105, corresponding hardware-specific drivers on accessory 110 are configured to exchange information with the drivers on mobile device 105 via the high bandwidth channel. By separating accessory device 110 from mobile device 105, hardware-level decisions may be separated from mobile device 105, thereby enabling subsequent enhancements and upgrades to accessory 110 without corresponding changes to mobile device 105.

In one implementation consistent with aspects described herein, buttons or other interface commands or portable handsfree (PHF) audio commands may be received during operation of the high bandwidth channel. Such commands may be received via the low bandwidth link using suitable AT commands or the like. For example, in the mobile television example, channel and volume change buttons may be provided on accessory device 110. Selection of these buttons may result in corresponding commands being received at mobile device 105 via the low bandwidth link. Similarly, accessory device 110 may include an audio device, such as a speaker or headset. Physical connection of accessory device 110 may result in audio being routed from mobile device 105 to accessory device 110, which may include a PHF device.

It may then be determined whether accessory device 110 has been detached (block 455). If so, the high bandwidth channel is disconnected, thereby returning mobile device to a low power mode (block 460). The process returns to block

If accessory device 110 has not been detached, it may be determined whether a disconnect command has been transmitted to accessory device 110 (block 465), such as in response to receiving a sleep request from the executing application, termination of the application, etc. In one exemplary implementation, accessory device 110 may include a network adapter, such as a wireless LAN adapter configured to provide or generate an ad hoc wireless network to additional mobile devices. Upon determining that no client devices are connected to the ad hoc wireless network, mobile device 105 may issue a corresponding command to disconnect the high bandwidth channel, thereby saving power. In an alternative implementation, the disconnect command may be generated by accessory device 110.

If a disconnect command has not been transmitted to accessory device 110, (block 465-NO), the process returns to block 450 for continued data/media exchange. However, if a disconnect or sleep command has been transmitted to accessory device 110 (block 465-YES), an acknowledgment of the command may be received from accessory device (block 470). Mobile device 105 may then receive an indication that the high bandwidth channel has been closed by accessory device (block 475). In one implementation, disconnection of the high bandwidth channel may include returning the vbus associated with interface 235 to low. The process then returns to block 430 (FIG. 4A).

An additional exemplary implementation of the above-described devices and corresponding processing is attached to this specification as Appendices A and B. The content of each Appendix is hereby incorporated by reference.

By providing a dual-power-level links via a common bearer interface, high bandwidth accessory devices may be configured and setup in an initial low power mode. The high bandwidth mode may be established only when necessary to support the functionality of the accessory device and its underlying application. Moreover, an initially handshaking operation may be performed for authenticating accessory devices prior to establishment of a high bandwidth link.

### Conclusion

Implementations described herein may provide a system and method for supporting high bandwidth accessories in mobile devices. In one implementation, an accessory device may be authenticated and setup via a low power link. A high bandwidth link may be established only when necessary by activating the high bandwidth link via commands received via the low power link.

The foregoing description of preferred embodiments of the invention provides illustration and description, but is not intended to be exhaustive or to limit the invention to the precise form disclosed. Modifications and variations are possible in light of the above teachings or may be acquired from practice of the invention.

For example, while the description above focused on accessory devices supporting mobile television reception and network adapters, it will be appreciated that additional accessory devices may be implemented. Additionally, although bearer protocols such as USB and IEEE have been identified, additional bearer protocols may also be implemented, such as proprietary serial protocols, infrared protocols, etc..

While series of acts have been described with regard to FIGS. 4A-4B, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving a request to configure a high speed link between a first device and a second device via a low speed link between the first device and the second device;
assigning a high bandwidth channel to the high speed link;
transmitting a channel identifier corresponding to the assigned high bandwidth channel to the second device via the low speed link;
determining whether the high speed link is necessary to perform an operation on the first device;
enabling the high speed link via the identified channel when it is determined that the high speed link is necessary to perform and operation on the first device; and
exchanging data between the first device and the second device via the high speed link.

2. The method of claim 1, further comprising:
authenticating the second device via the low speed link.

3. The method of claim 2, wherein the authenticating is performed prior to assigning the high bandwidth channel to the high speed link.

4. The method of claim 1, wherein the authenticating comprises:
receiving an encrypted authentication request via the low speed link;
determining whether the encrypted authentication request was encrypted using an authorized encryption key; and
authenticating the second device when it is determined that the encrypted authentication request was encrypted using an authorized encryption key.

5. The method of claim 4, wherein the encryption key is a private key associated with an authorized manufacturer of the second device.

6. The method of claim 1, further comprising:
receiving a request to disable power charging from the second device.

7. The method of claim 6, wherein the request to disable power charging is received via the low speed link.

8. The method of claim 1, wherein the high speed link comprises a universal serial bus (USB) interface.

9. The method of claim 8, wherein the identified high bandwidth channel is a USB channel and wherein enabling the high speed link comprises setting a vbus associated with the identified USB channel to high.

10. The method of claim 1, wherein the high speed link comprises an IEEE 1394 interface.

11. The method of claim 1, wherein the first device is a mobile communication device and wherein the second device is a high bandwidth accessory device.

12. The method of claim 11, wherein the high bandwidth accessory device comprises one of a mobile television receiver or a wireless networking adapter.

13. The method of claim 1, further comprising:
determining whether a disconnect request has been received; and
disabling the high speed link when it is determined that the disconnect request has been received.

14. The method of claim 13, wherein the disconnect request indicates that a sleep command has been received from an application executing on the first device.

15. A mobile device, comprising:
a communications interface; and
a processor configured to:
determine whether an accessory device has been attached via the communications interface,
configure a high bandwidth link to the accessory device via an initial low power link to the accessory device, and
connect to the accessory device via the high bandwidth link when necessary to perform an operation.

16. The mobile device of claim 15, wherein the communications interface comprises a universal serial bus (USB) interface.

17. The mobile device of claim 15, wherein the processor is further configured to authenticate the accessory device prior to configuring the high bandwidth link.

18. The mobile device of claim 17, wherein the authentication comprises a public-key cryptographic authentication.

19. The mobile device of claim 15, wherein the low power link requires less power than the high bandwidth link.

20. A device, comprising:
means for authenticating a second device to a first device via a low power link;
means for configuring a high bandwidth link between the first device and the second device via the low power link upon authentication of the second device to the first device;
means for connecting the first device to the second device via the high bandwidth link.
